(19) United States
(12) Patent Application Publication
(10) Pub. No.: US 2015/0238387 A1
(43) Pub. Date: Aug. 27, 2015

(54) CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS

(71) Applicant: Norival CAETANO, (US)

(72) Inventor: Norival Caetano, Sao Paulo (BR)

(21) Appl. No.: 14/419,093

(22) PCT Filed: Jul. 26, 2013
(86) PCT No.: PCT/BR2013/000273

§ 371 Date: Feb. 2, 2015

(30) Foreign Application Priority Data
Aug. 2, 2012 (BR) BR1020120193353

(51) Int. Cl. A61J 1/14; A61J 1/20; A61J 1/10

(52) U.S. Cl. CPC A61J 1/1418; A61J 1/1406; A61J 1/10; A61J 1/2048; A61J 1/2096

(57) ABSTRACT

“CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, which includes one cap itself that is indicated by the numeric reference (1), which is complemented by one overcap (2), being the cap (1) one piece produced in plastic polymer achieved by injection molding and that is formed by one disc-shaped section (3) that is complemented by one vertical contouring wall (4), this latter being garnished downward, in its internal region, by one thicken and turned inward border (5); from the center of the circular face of the disc-shaped section (3) one tubular connection (6) elaborated in the “luer” standard goes vertically upwards, having in its outer wall one outer screw cap wire 7; the circular face periphery of the cap (1) disc-shaped section (3) shows one upwards prominent border (8) ending in one sharp edge (9), while the underside (10) of the disc-shaped section (3) is upheld in the bottlehead (F1) of the bottle (F).

This specification relates to an invention patent, which discloses a cap having a hypodermic syringe coupling connection, said cap including a corresponding overcap. The cap and overcap assembly herein presented aims to be a viable alternative to the stoppers normally employed for sealing bottles that serve as packaging for medicine products, notably bottles with filled pharmaceutical and injectable medicine products.

The inventor of this new type of bottle sealing means for packaging medicine products, notably bottles for pharmaceutical and injectable medicine products, has been researching for the last seven years subjects related to injectable products, and one of these researches resulted in conclusions regarding some aspects of primary importance, which were liable to improvement.

The researches eventually resulted in two distinct patent applications, which address different and specific subjects, but fully interrelated and encompassed, on a larger scale, by the scope of pharmaceutical and injectable medicine products.

The first of these two patent applications is PI 0822673-3, filed in Feb. 14, 2011, entitled “PADRONIZA [symbol] ÃO DE MEDICAMENTOS INJETÁVEIS E SEUS DILUENTES [STANDARDIZATION OF INJECTABLE MEDICINE PRODUCTS AND THEIR DILUENTS]”, in which coding between products×diluents is proposed with the inclusion of a new standardized labeling model. Objectively, the aforementioned patent application aims to establish a new standardization in this segment, thus preventing mistakes in reconstitution and dilution, as well as in the administration of pharmaceutical products and similar.

The second patent application originated from the researches carried out by the present inventor is PI 1003460-9, which refers to a new bag for diluents, or liquid injectable medicine products.

The aforementioned patent application was filed in Sep. 29, 2010 and is entitled “BOLSA PARA ACONDICIONAMENTO, RECONSTITUI [symbol] ÃO E/OU DILUI [symbol] ÃO DE PRODUTOS DE USO INJETÁVEL E DISPOSITIVO DE SEGURAN [symbol] A APLICÁVEL EM FRASCO DE MEDICAMENTO A SER RECONSTITUÍDO E/OU DILUIDO EM UMA BOLSA PARA ACONDICIONAMENTO, RECONSTITUI [symbol] ÃO E/OU DILUI [symbol] ÃO DE PRODUTOS DE USO INJETÁVEL [BAG FOR PACKING, RECONSTITUTION AND/OR DILUTION OF INJECTABLE PRODUCTS AND SAFETY DEVICE APPLIED TO A BOTTLE FOR MEDICINE PRODUCTS TO BE RECONSTITUTED AND/OR DILUTED INSIDE A BAG FOR PACKING, RECONSTITUTION AND/OR DILUTION OF INJECTABLE MEDICINE PRODUCTS]”, which incorporates a series of positive aspects when compared to conventional bags.

Among the various innovative aspects which characterize the type of bag proposed on PI 1003460-9 are the possibility of direct coupling of a hypodermic syringe without the use of a needle, possibility of direct coupling of a conventional bottle of the type used for packaging of pharmaceutical and injectable medicine products, possibility of inlet/outlet connections with a sealing system and means for enabling repeated opening/closing cycles as well as fractioned dosage, filtering means for preventing rubber particles (“coring”), generated by the perforation of conventional corks with needles or a Spike (plastic needle), from entering the inner environment of the bag and be wrongly administered to the patient.

Proceeding with his researches, the inventor turned his attention to another aspect related to pharmaceutical products and injectable medicine products, that is, the type of sealing method adopted for closing the bottles, which is normally defined as a stopper employed in closing the bottles used as packaging for injectable medicine products, seeking a project solution which allows the conception of a new and original sealing method, which, in opposition to the conventional stopper, may be defined as “No Coring Stopper” (in which “coring” means the generation of particles), thus the denomination of the new sealing method as “No Coring Stopper” (a sealing method in the form of a cap and its overcap, applicable on bottles for pharmaceutical and injectable medicine products for which this sealing method may be considered free of particle generation).

The inventor found out that an ideal sealing method for injectable medicine product bottles should among other aspects ensure: Complete sealing of the bottle; maintenance of product sterility; easy and safe utilization, and no particle generation during reconstitution and removal of the product from the bottle.

Current stoppers belonging to the state of the art only fulfill a fraction of these objectives, as they provide good sealing, although requiring an aluminum-seamed seal for keeping the stopper on the bottle's head; made of rubber polymers, they receive external sterilization, which does not ensure sterility inside the stopper which will be penetrated by needles and “spikes” (plastic needles) and generate particles (“Coring”) when penetrated, and it should be noted that the inner sterility of the masses of said generated particles cannot be determined.

It should also be considered that current stoppers have an upper plastic protection called “flip off”, which leads to a false state of sterility. This “flip off” only prevents direct contact with external contaminants, but does not ensure external sterility of the stopper, therefore requiring cleaning of the surface of the stopper using a swab soaked in alcohol prior to penetrating it with a needle.

The penetration of rubber stoppers by metallic needles (and also by plastic spikes), as well as generating particles, is a procedure that often causes accidents due to puncturing.

In light of these facts, a new genre of sealing method was developed, in the shape of a cap and an overcap, which supersedes the limitations of conventional rubber stoppers, as it uses synthetic materials, liable to full sterilization and already with proven compatibility with medicine products, as well as completely eliminating the use of needles for preparing the product, thus avoiding the aforementioned accidents due to puncturing.

The new sealing method presented by this invention patent application is accomplished in the form of an innovative cap and its respective overcap, both made of a plastic polymer (various polymers previously studied are compatible with injectable medicine products, as mentioned), incorporates a connection which constitutes a door for injection of diluents and removal of the product with no use of needles and, as it features an edge for external locking which mechanically attaches to the surrounding border normally incorporated to the top of the bottleneck, avoids the need of an aluminum re-sealing seal for the stopper.

In the context of the subject of this patent application, the initial and baseline concept to be learned is that a pharmaceutical product for parenteral use (injectable) in powder form, stored in a glass bottle, is not a finished product.

A finished product for parenteral use must be in liquid form. As such, this powder in a glass bottle is a product, which requires a final manufacturing phase in order to recover the form needed for injectable use, which is the liquid form.

Any manufacturers of powdered products for parenteral use must provide proper instructions and means for this final manufacturing process to be executed according to the Good Manufacturing Practices.

The question that remains is: Does the Pharmaceutical Industry provide these conditions when putting powder in a glass bottle, sealed by a rubber stopper, and releases it to the market to be “reconstituted”? The answer is no. The industry releases its products frequently without proper instructions, without validation of compatible diluents, occasionally even eliminating the plastic flip offs (protective plastic layer over the stopper) and falling back to full aluminum seals which forces nursing and pharmaceutical professionals to rely on precarious tools such as scissors or metal spatulas in order to access the rubber stopper. These stoppers are traditionally made of natural or synthetic rubber, include leachable components (which may be released and contaminate products that come into contact with them), sterilisable only externally through autoclaving and/or radiation and, in spite of all these aspects (leachable and containing non-sterile inner particles), are to be penetrated by a metallic needle or by spikes (plastic needles) generating particles.

Therefore, the final manufacturing process (reconstitution) of a parenteral product currently has no conditions to be concluded without a great chance of contamination and/or particle generation, aside from the possibility of accidents due to puncturing, going against the provisions of the Good Pharmaceutical Manufacturing Practices.

Only by understanding this concept, it is possible to capture the importance and the revolution that a new sealing method, such as the method presented herein, shall provide within the pharmaceutical segment.

This sealing method shall compel laboratories to rethink their responsibilities regarding the final manufacturing process of powder products for injection, a phase that is known nowadays as product reconstitution, when in fact it is still a finishing procedure of manufacturing that the laboratories delegate to hospitals. Moreover, since it must be this way, the proper tools for finishing this procedure must be provided.

The new sealing method, conveyed as a plastic cap (and its respective overcap) presented herein is attached to the bottle by threading from its upper external edge, with a central connection to the “negative Luer” and the overcap to the “positive luer”. The overcap is fixed prior to the cap and sealed by a plastic seal (breakable welding line) which shall be broken only when the product is about to be used.

This cap and overcap assembly may be mounted in three ways: a) for non-freeze-dried products, the protection cap (overcap) is previously sealed by a plastic seal to the cap, which shall only be broken in order to enable product usage; b) for freeze-dried products, the protection cap (overcap) is only welded to the cap after the freeze-drying process, because this process requires an open space on the cap for sublimation (exhaustion of the steam formed by the direct transition from solid to gaseous state), highlighting that this opening shall have a calculated diameter in order to ensure proper parameters for freeze-drying; c) a varying assembly for freeze-dried products conveys the same cap already with a fixed and sealed overcap, but with a central cone positioned towards the inner part of the bottle, close to the glass wall and with a series of round openings through which the steam from the freeze-drying process will be released, prior to the full sealing of the bottle.

As the new cap is made of plastic and cannot be penetrated by needles, a “luer” device was placed on the center part of the cap for direct connection to the syringes or to a special bag model for diluents with a “luer” terminal and an open-close mechanism, such as established on the patent application PI 1003460-9.

The new cap (and its overcap) is inserted in the manufacturing process without requiring any complex changes to the sterile filling machines used nowadays (for example, the MD-300 Zanasi model), only requiring small adaptations to the feeding trays of filling machines (not affecting the main structure of the machine).

A plastic welder for the protection cap (overcap) shall only be used when the cap mentioned herein must be employed for closing bottles containing freeze-dried products. If, in this case, a cap assembly is preferred, in which the fixed and sealed overcap is already incorporated and has a center cone with openings for releasing steam, the plastic welder is eliminated from the filling process of freeze-dried products.

The reconstitution of a product packed in a bottle sealed by this new cap shall be done through secure steps, with no risks of accident by puncturing, no particle generation and no product contamination: The seal of the protective cap is opened, directly attaching the syringe with a positive “luer” terminal (no needle use). The reconstitution is performed by keeping the syringe attached to the bottle through the “luer” terminals (the syringe attached to the bottle ensures extra protection in order to ensure the sterility of the procedure). The following step is: a) transferring a product to a dilution bag, or b) attaching a needle for direct injection (when direct injection is allowed and indicated).

The bottle may also (provided the product allows direct contact with the diluents) be directly attached to the diluents bag (presented on the PI 1003460-9), also provided with a “luer” terminal and proper open-close mechanism, constituting a real closed system for reconstitution and dilution of medicine products.

The new cap herein presented, by dismissing the need for needles for reconstitution procedures (worth noting that a needle is used for reconstitution and another for administration), brings economy to the reconstitution process, by using less needles, reducing the necessary time for preparation of injectable medicine products and also by preventing accidents due to puncturing.

The whole reconstitution shall be performed in a safe manner, with no particle generation, quickly and free of risk of accidents due to puncturing. It should be reminded that the Good Manufacturing Practices (here incorporated to the reconstitution process of a product, which, as already pointed out, is a final manufacturing process) recommend that all these procedures are executed under a validated laminar flow and by trained technical personnel.

In case of preparation of a product outside of the laminar flow, as usually happens on hospitals around the world, the focus of concerns shall be exclusively over the observation of aseptic techniques, with concerns over particle generation and accidents due to puncturing previously eliminated.

Objectively, the “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”. presented herein comprises the following general features:

a) as opposed to conventional rubber-made stoppers, it is manufactured in plastic polymer (many types already validated for pharmaceutical use);

b) Includes a negative “luer” center terminal and an overcap with a center positive “luer”;

c) Cap assembled with an overcap, connected between them in a manner that the overcap is sealed to the cap through a plastic seal;

d) Cap and overcap featuring a safety area which enables handling without contamination of the central surface;

e) When applied to a bottle containing a medicine product in need of reconstitution, enables said' procedure (reconstitution) to be performed with the syringe directly attached to the cap and, consequently, directly attached to the bottle (ensuring maintenance of sterility);

f) Immediately after the reconstitution, the product may be drawn into the syringe, transferred to a diluent bag, or to a bag with a “luer” terminal (said bag referred on patent application PI 1003460-9) in order to avoid using the needle again;

g) Allows easier fractioning of the dosage, without particle generation (no rubber to be transfixed), solving a constant problem, especially in pediatrics;

h) Saves materials due to not using needles and, above all, substantially increasing the speed of

i) the preparation process of injectable products; and

j) Eliminates the risk of accidents due to puncturing, as needles are no longer used.

The sealing method presented in this invention patent application, and conveyed in the form of an innovative cap and its corresponding overcap, may be fully understood through the detailed description to be done as per the figures listed below, in which:

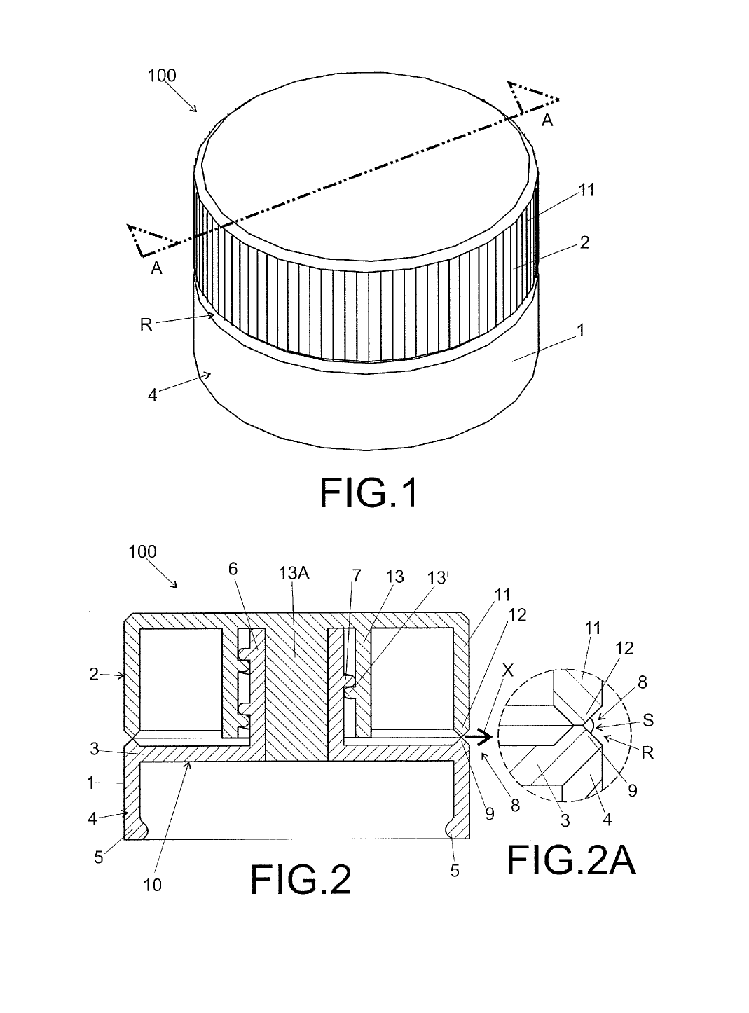

FIG. 1 shows a perspective view of the main cap model presented herein;

FIG. 2 shows a sectional view, taken according to the cut line “A”-“A” indicated on FIG. 1;

FIG. 2A is an expanded detail view taken from FIG. 2, as indicated by the X arrow and referring to the joining or sealing region produced between the cap and its overcap;

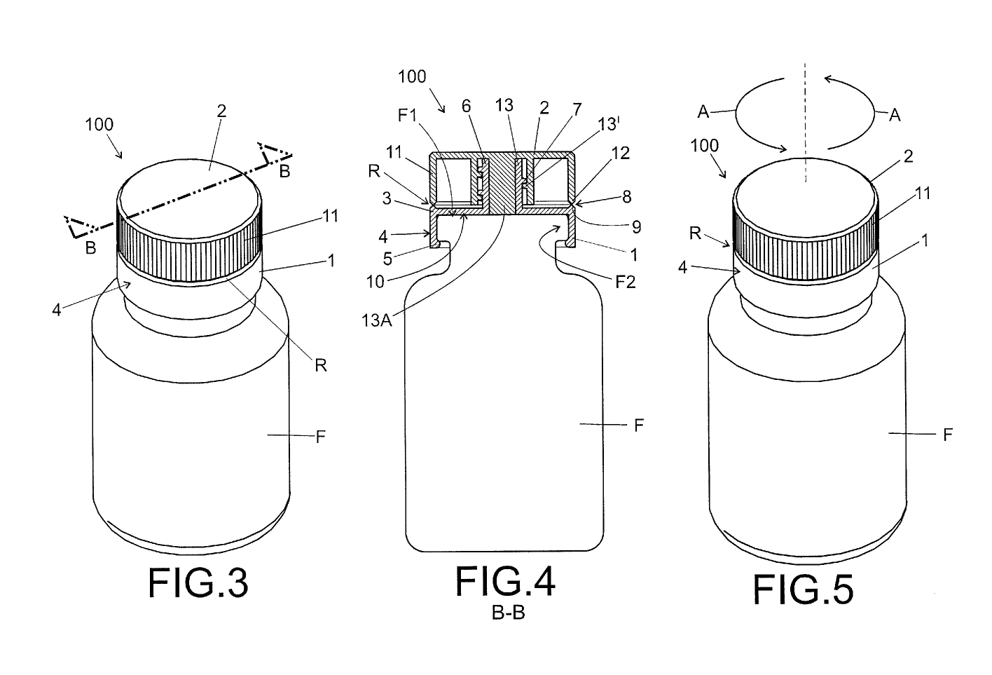

FIG. 3 shows a view of the cap presented herein properly assembled on a generic bottle model of the type commonly used for packaging of pharmaceutical or injectable medicine products;

FIG. 4 shows a general sectional view of the bottle and cap presented herein, in which said section is taken according to the cut line “B”-“B” indicated on FIG. 3;

FIG. 5 schematically shows the rotation direction that must be employed in order to detach the overcap from the cap, with the latter remaining tightly fixed to the bottle; in the present figure the rotation direction is indicated by the “A” arrows pointing counterclockwise;

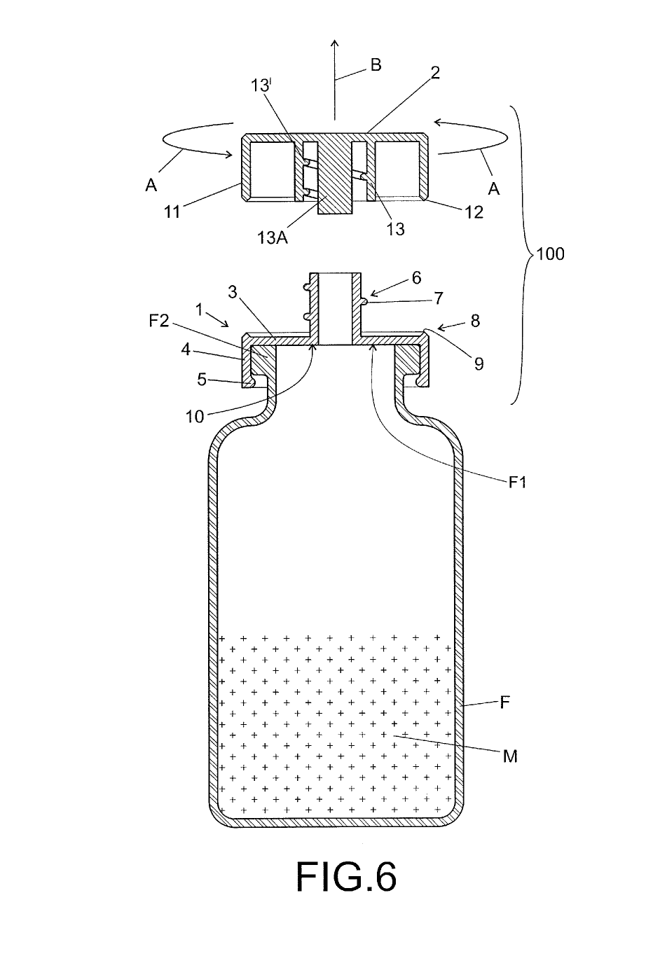

FIG. 6 shows a schematic section based on the condition initially shown on FIG. 5, where the overcap is removed while the cap remains tightly fixed on the top of the bottleneck; in this figure the arrows indicating the rotation direction for removal of the overcap follow those indicated on FIG. 5 and are referred as “A” arrows, while the “B” arrow indicated the detachment direction of the overcap from the cap;

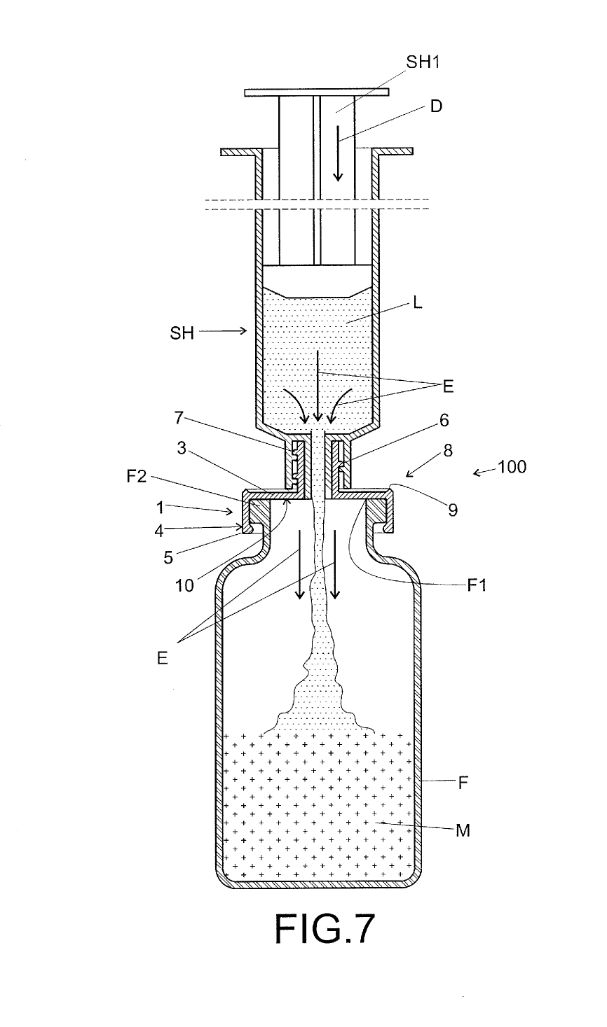

FIG. 7 schematically shows the possibility of direct attachment between a hypodermic syringe (not equipped with a needle) and the cap assembled on the bottle, in which the aforementioned figure indicates that the reconstitution liquid inside the syringe is being introduced in the bottle, as demonstrated by arrow “D” which represents the pressing movement of the syringe plunger, and also arrows “E” which represent the flowing direction of the reconstitution liquid when leaving the syringe and into the bottle;

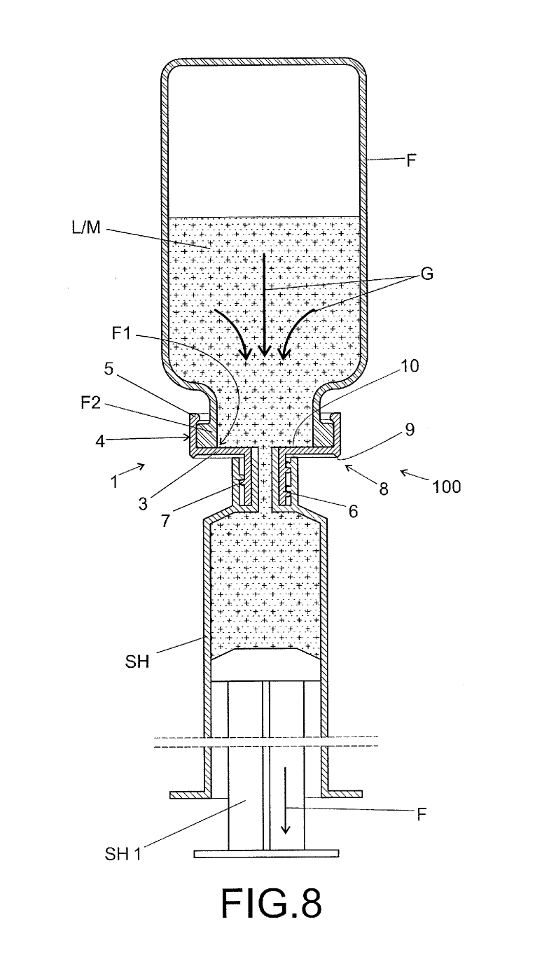

FIG. 8 shows the subsequent stage to the one shown by FIG. 7 and in which the reconstitution liquid has already been properly homogenized to the product (originally in powdered form) stored within the bottle; this figure shows the product, already reconstituted, being drawn into the hypodermic syringe, as may be seen by arrow “F” which represents the retraction movement of the plunger, and also the “G” arrows indicating the flow direction of the reconstituted product flowing inside the syringe;

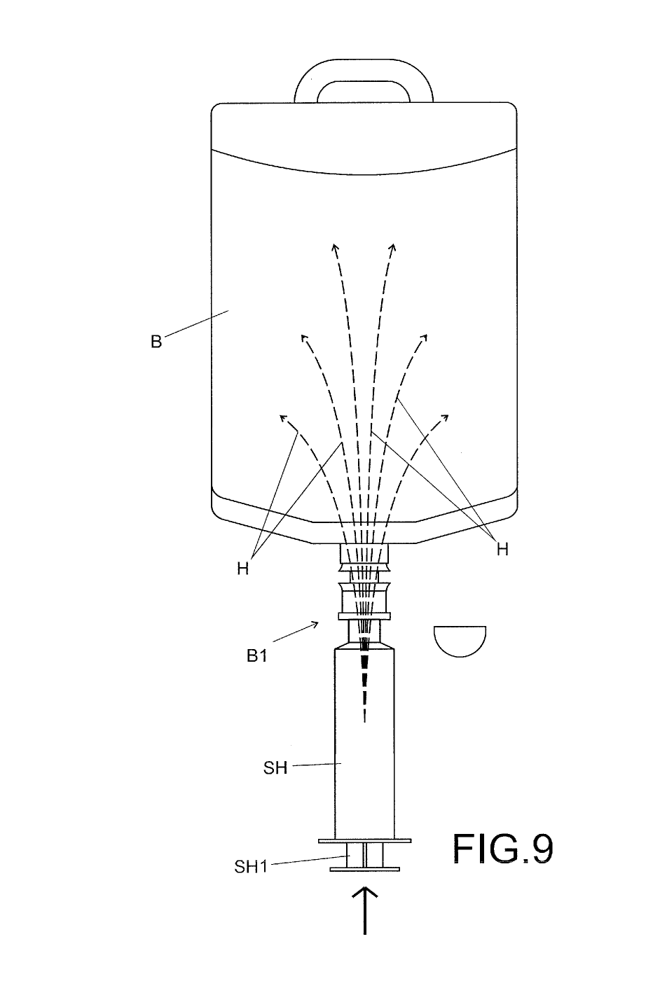

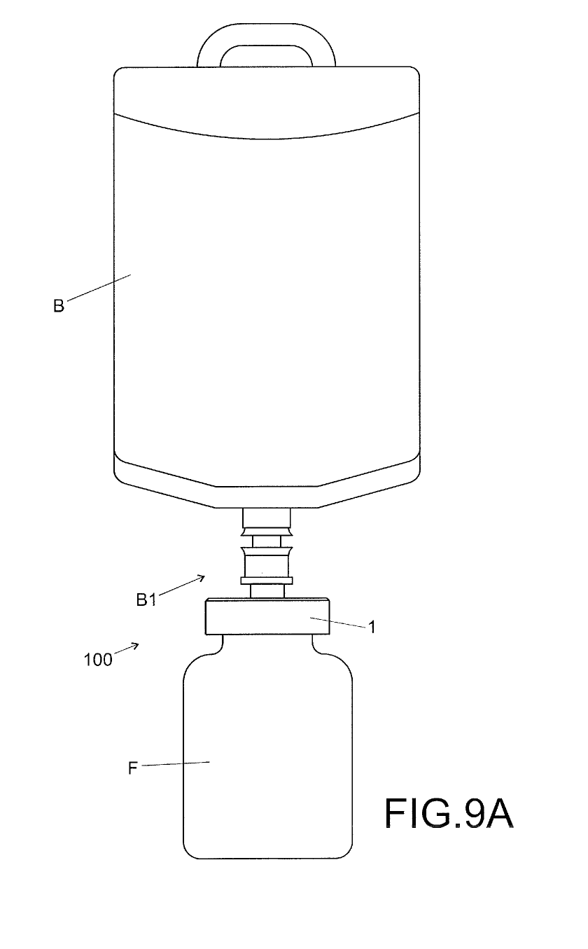

FIG. 9 schematically shows the possibility of direct attachment between a syringe and a bag such as the one proposed on the patent application PI 1003460-9; this figure, although not showing any subjects effectively claimed on this patent application, demonstrates the dynamic of preparation of pharmaceutical and/or injectable medicine products which was made viable, on previous stages, by the employment of the cap presented herein as a sealing method for the bottle, such as showed on FIGS. 7 and 8; the present figure includes “H” arrows that represent the intake flow of reconstituted product which is administered to the bag;

FIG. 9A schematically shows the possibility of direct attachment between a bottle featuring the cap assembly subject of this invention patent application and a bag as presented on the patent application PI 1003460-9; said FIG. 9A shows this possibility of direct attachment, which is useful in cases where the reconstitution and dilution of the medicine product may be performed with the same diluent;

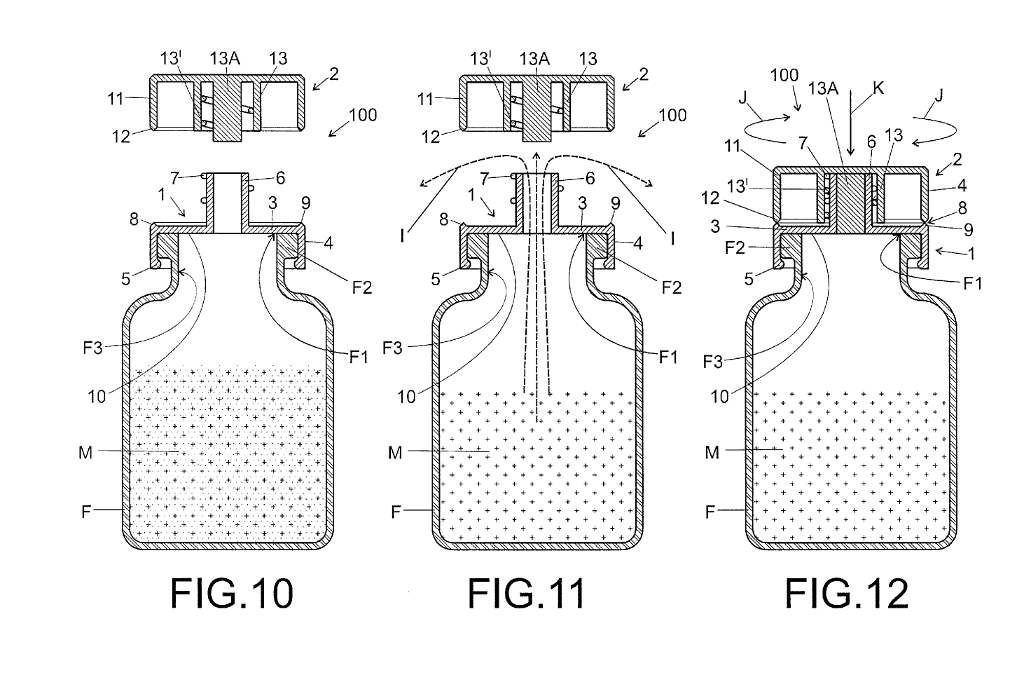

FIG. 10 shows one utilization model of the cap presented herein when used for sealing of bottles containing freeze-dried pharmaceutical or injectable medicine products; it is schematically demonstrated in this figure the fact that the cap may be initially fixed to the bottle even if not equipped with its correspondent overcap;

FIG. 11 shows, also schematically, the stage according to which the bottle filled with liquid product to be freeze-dried loses, through sublimation, the steam resulted from its liquid state; in this condition the overcap must be pulled away from the cap so that the gases generated may find a quick way out of the bottle, such as indicated by the “I” arrows;

FIG. 12 shows, also schematically, the assembly condition of the overcap in relation to its respective cap, thus ensuring hermetic sealing of the bottle; on the present figure, the clockwise rotation that leads to fixation of the overcap is represented by the “J” arrows, while the resulting approaching movement verified between the overcap and the cap is indicated by the “K” arrow; a plastic welder shall perform the fixation of the overcap to the cap;

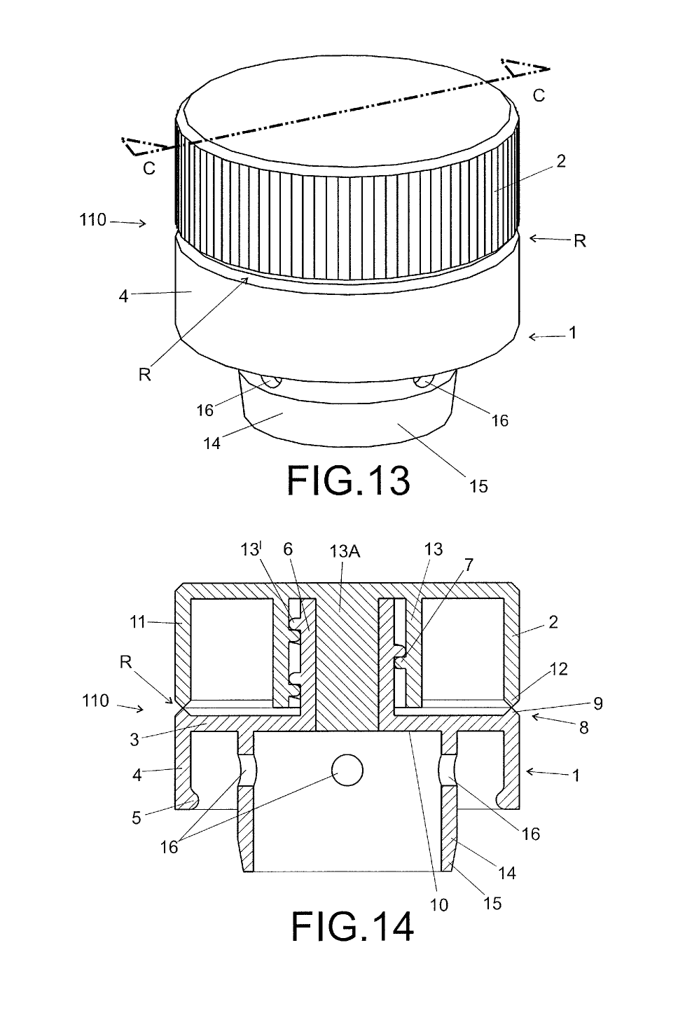

FIG. 13 shows a first variation of the cap presented herein, which is specifically prepared to be used with liquid products that need to go through a freeze-drying process;

FIG. 14 shows a full section taken from FIG. 13, such as indicated by the cut line “C”-“C”, thus demonstrating the inner portion of said first variation;

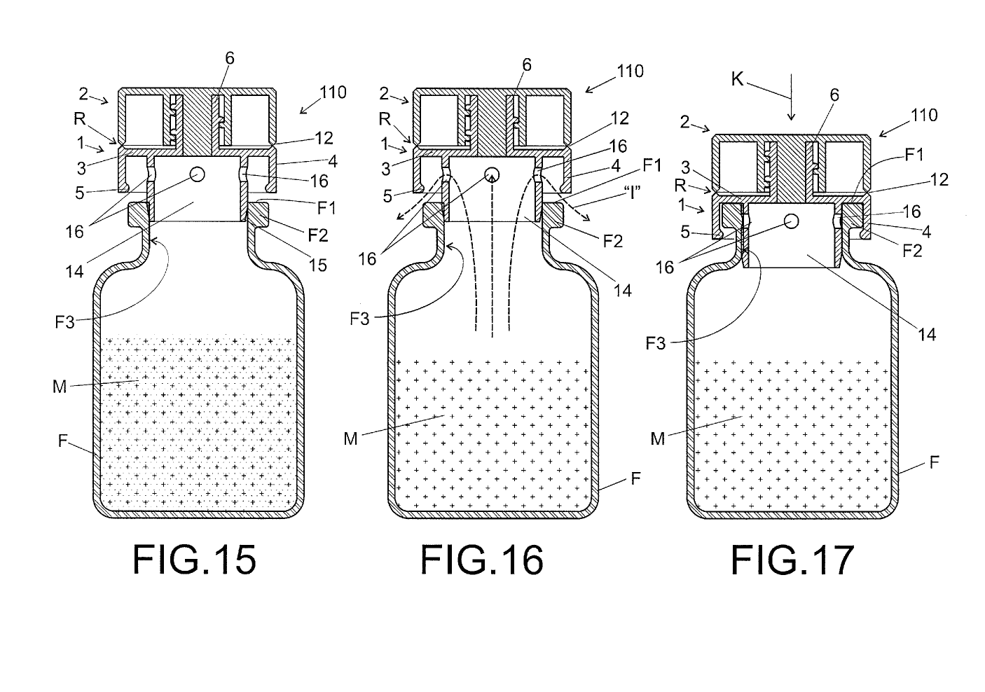

FIG. 15 shows the cap produced according to the first variation and which is destined to be used for sealing bottles with pharmaceutical or injectable medicine products that must be submitted to a freeze-drying process; it is schematically demonstrated in this figure the fact that the cap may be initially introduced in the top of the bottleneck, up to a level in which the orifices for vapor release are left unobstructed;

FIG. 16 shows, also schematically, the stage according to which the bottle filled with liquid product to be freeze-dried loses, through sublimation, the steam resulted from its liquid state; in this condition the gases leave the bottle through the orifices formed on the central portion of the cap, which become a quick outlet, such as indicated by the “I” arrows;

FIG. 17 shows, also schematically, the finishing assembly condition of the first variation of the cap presented herein to the top of the bottleneck; in the present figure the approaching movement between the cap as a whole and the bottleneck is indicated by the “K” arrow;

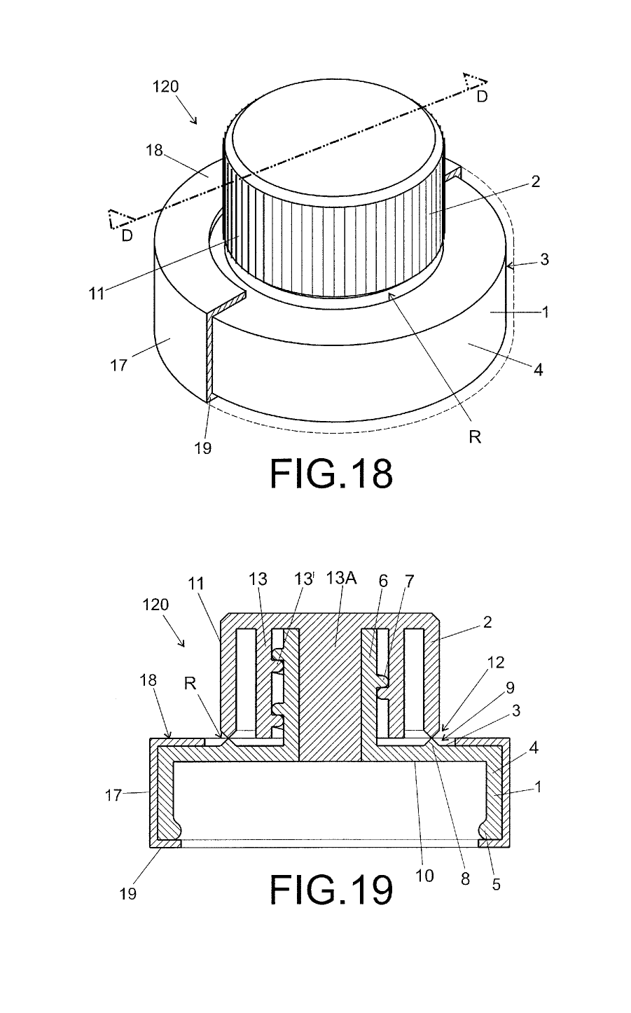

FIG. 18 shows a second variation of the cap presented herein, which features a different setup regarding the overcap and employs, as a resource for strengthening the fixation of the cap to the bottle, a re-sealing seal, which may be preferably obtained through employment of plastic matter;

FIG. 19 shows a section taken from the cap conveyed as a second variation, with said section taken according to the cut line “D”-”D of FIG. 18;

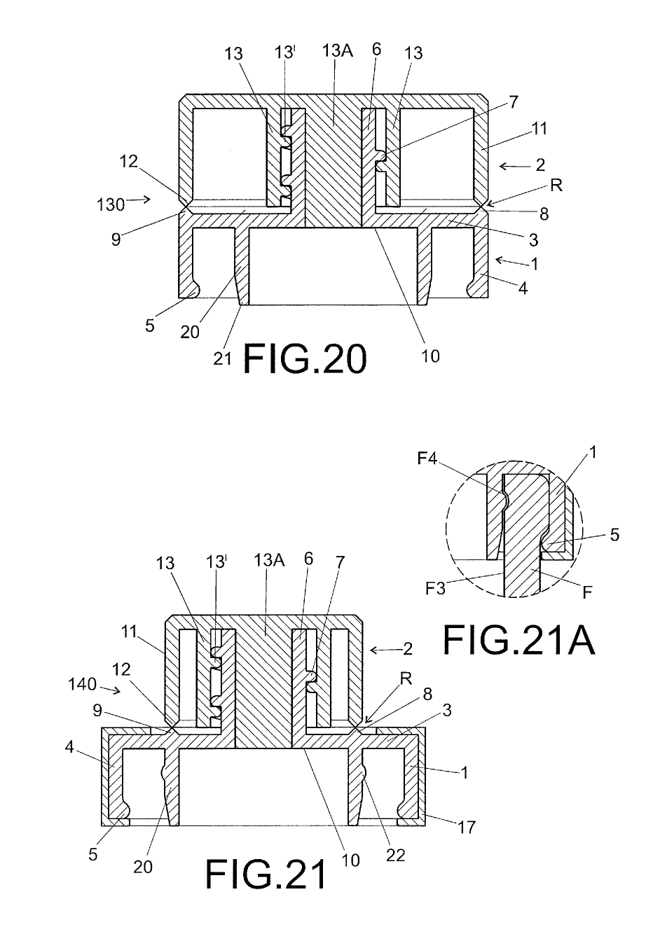

FIG. 20 shows a schematic sectional view of a third variation of the cap presented herein, which includes a central projection on the lower region, serving as a facilitating guide for fixation of the cap;

FIG. 21 shows a fourth variation of the cap presented herein, which is derived from the model of FIGS. 18 and 19 and includes a central projection, such as verified and described on the model of FIG. 20;

FIG. 21A shows a schematic detail which demonstrates the contact between the central projection which joins the cap and the inner wall of the bottleneck against which the cap is applied to;

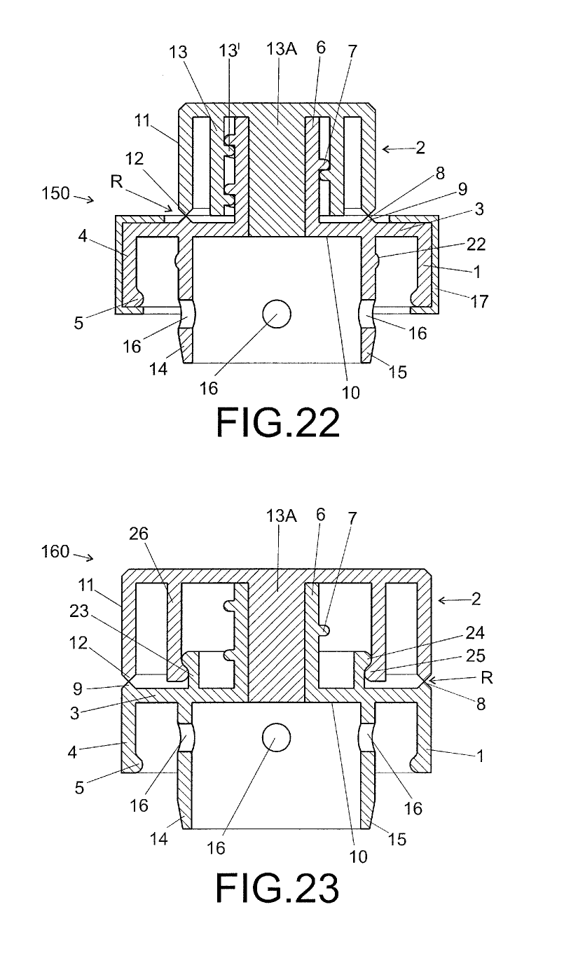

FIG. 22 shows a fifth variation of the cap, subject of this invention patent application, which is derived from the cap model of FIGS. 18 and 19 and includes a central projection on the lower region, suitable for cases in which the bottles are to be filled with liquid products that must be submitted to a freeze-drying process;

FIG. 23 shows a sixth variation of the cap presented herein, which is derived from the model on FIG. 22 and includes a distinct system for fixation of the overcap in relation to the cap itself, a system which employs reciprocating retaining ribs between the cap and the overcap;

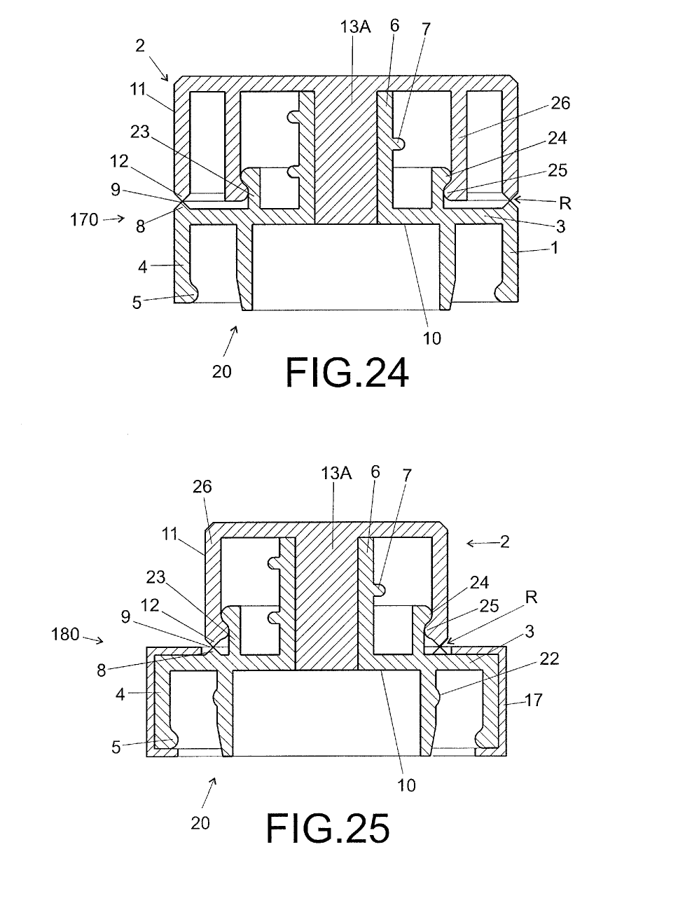

FIG. 24 shows a seventh variation of the cap subject of this invention patent application, which is a variation of the cap model from FIG. 23 regarding its overcap, but also includes a central projection, serving as a facilitating guide for fixing the cap, on the lower region, for employment in bottles destined to the packaging of products which do not need to be submitted to freeze-drying processes;

FIG. 25 shows an eighth variant of the cap subject of this invention patent application, which includes an overcap of reduced diameter and a fixation system to the cap according to the model demonstrated on FIG. 23 and featuring a re-sealing ring such as the models of FIGS. 18, 19, 21 and 22;

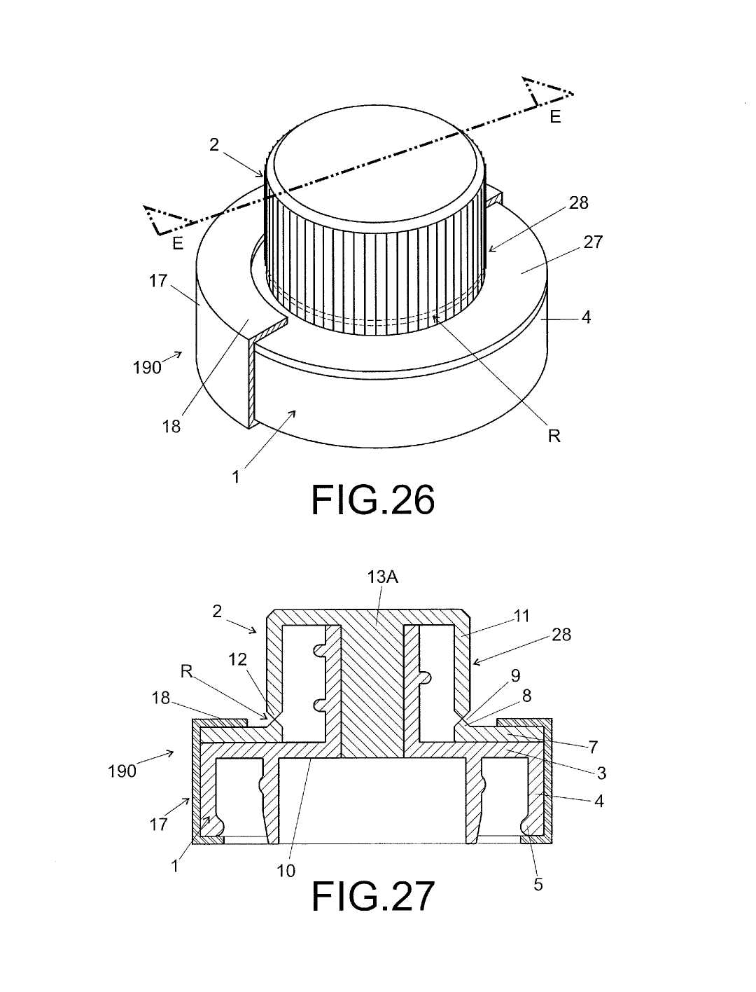

FIG. 26 shows a ninth variation of the cap presented herein, which features an overcap with a distinct drawing, fixed to its cap through a re-sealing ring which may be manufactured in plastic; and

FIG. 27 shows a section taken from FIG. 26, such as indicated by the cut line “E”-”E of FIG. 26.

According to what was shown in the aforementioned figures, the “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, subject of this invention patent application, features a main model of the cap presented herein, as may be seem on FIGS. 1 to 8 and indicated, as an assembly, by reference 100.

The cap assembly 100 includes a proper cap which is indicated by numerical reference 1, complemented by an overcap 2, being a plastic polymer component obtained through molding by injection and formed by a disc-shaped section 3 which is complemented by a surrounding vertical wall 4, the latter being covered, on the lower internal region, by a thick inward curved border 5.

From the center of the circular face of the disc-shaped section 3, a tube connection 6 elaborated in the “luer” standard goes vertically upwards, having in its outer wall an outer screw cap wire 7.

The periphery of the circular face of the disc-shaped section 3 of the cap 1 features an outstanding upwards border 8 which ends in an acute edge 9, while the inner face 10 of the disc-shaped section 3 is supported by the bottleneck F1 of bottle F.

The cap assembly in its main version 100 also features an overcap 2, which, such as verified regarding the cap 1, it is also manufactured in plastic polymer and through molding by injection.

The overcap 2 presents a new disc format featuring a surrounding wall 11, dimensioned in order to have, preferably, the same diameter as the cap 1.

The lower border of the surrounding wall 11 ends in an acute edge 12 identical to edge 9 incorporated to cap 1.

The central and lower regions of the overcap 2 feature a tube projection 13, also according to the “luer” standard and with an internal thread wire 13′, which complements and connects to the “luer” connection 6 through the thread wire 7, which is part of the cap 1. The tube projection 13 features a cylindrical projection 13A centrally and coaxially positioned, which enters the tube connection 6 of the cap 1.

The edges 9 and 12 of the cap 1 and overcap 2 are produced in order to face one another and be joined together by a weld S, such as verified on FIG. 2A, with this weld line S constituting the breakage region or line R to be effectively broken at the moment of separation of the overcap 2 regarding the cap 1.

The main model 100 of the cap and overcap assembly presented herein may be assembled in a generic bottle model F, as may be seen, initially, on FIGS. 3 to 8, with this assembly performed so that the botton face 10 of the cap 1 is in contact with the upper border of the bottleneck F1 of bottle F, while the thick border bent inwards 5 establishes a locking condition with surrounding borders F2 of said bottle F, such as depicted on FIGS. 4, 6, 7 and 8.

The cap assembly 100, which constitutes the main cap model presented herein is conveyed in order to allow the assembly against the bottle F by compression, with the retention generated by the thick border bent inwards 5 of the cap 1 and the surrounding border F2 of bottle F.

After filling the product within the bottle F, it is then closed by applying the cap 1 (and overcap 2) over said bottle, which was submitted to previous welding of edges 9 and 12 of the cap 1 and overcap 2, such as demonstrated on FIG. 2A, while on the moment of opening bottle F, the overcap 2 must be rotated, as indicated by the “A” arrows of FIG. 6, being simultaneously separated of cap 1, such as indicated by arrow “B” of the same FIG. 6, an operation which required breaking the breakage line R up to the established by the welding S of edges 9 and 12.

Upon removal of the overcap 2, the “luer” connection 6 of cap 1 allows for the occurrence of the procedure shown on FIG. 7, where a SH hypodermic syringe is used to introduce, directly to the bottle F, a given volume of liquid L for reconstitution of powdered medicine product M stored in the bottle F.

FIG. 7 shows the forward movement of the plunger SH1 of the syringe SH as the reconstitution liquid L inside the syringe may be transferred to the bottle F, such as indicated by the “E” arrows.

The connection between the syringe SH and the bottle F is possible precisely because the SH syringe also features, conventionally, a connection of the same “luer” standard, such as previewed on cap 1.

FIG. 7 schematically shows the possibility of direct attachment between the hypodermic syringe SH (not equipped with a needle) and the cap 1 of the assembly 100 mounted near the bottle F.

The reconstitution of medicine product M such as showed on FIG. 7 is performed with no parts of the cap 1 being penetrated by the needle of the hypodermic syringe AH, which, such as commented before, has no needle.

Thus, the reconstitution operation takes place safety, quickly and with no particle generation.

FIG. 8, on the other hand, shows the subsequent stage described by FIG. 7 and in which the reconstitution liquid L has already been properly homogenized to the medicine product M stored in the bottle F; this figure shows the product (reconstituted M medicine) being drawn into the hypodermic syringe SH, as may be seen by arrow “F” which represents the retraction movement of the plunger SH1 of the SH syringe, and also the “G” arrows indicating the flow direction of the reconstituted product (reconstituted M medicine) flowing inside the SH syringe;

Upon transfer of the reconstituted M medicine to the hypodermic syringe SH, it may then be manipulated as shown, for example, on FIG. 9, where it is schematically demonstrated the possibility of direct attachment of the hypothermic syringe SH and a bag B, such as the proposal on patent application PI 1003460-9 of this same applicant.

FIG. 9 serves to demonstrate the preparation dynamics of pharmaceutical substances and/or injectable medicine products that were made viable, in previous stages, due to employment of a cap assembly 100 (cap and overcap), proposed previously.

In the aforementioned FIG. 9 the “H” arrows represent the inlet flow of the reconstituted product (reconstituted medicine product M) which is administered to the bag B through its inlet door B1 which also features a “luer” terminal.

Optionally the cap presented herein also allows the possibility of direct attachment to a bag B with “luer” standard in cases where the reconstitution and dilution of the medicine product may be performed with the same diluent, which is correct to say that in this case only one operation is performed, that is, reconstitution and dilution.

FIG. 9A shows exactly the condition according to which a bag B of the type described in the patent application PI 1003460-9 may be directly attached, through its inlet door B1 which features a respective connection in the “luer” standard, the “luer” connection of cap 1 mounted on a bottle F. Regarding FIG. 9A, the cap assembly shown is indicated by numerical reference 100, which does not exclude the condition in which the same type of direct connection may be established with any of the other versions of the cap assembly in question.

FIGS. 10, 11 and 12 show the cap assembly 100 presented herein in a condition in which it is employed with bottles F that must store liquid medicine products, which must be submitted to a freeze-drying process.

Among FIGS. 10, 11 e 12, FIG. 10 shows an initial stage, where the medicine product M, still in its liquid phase, is already packed within bottle F and where said bottle F is now equipped with a cap 1 still separated from its overcap 2.

FIG. 11 schematically shows what occurs at the moment of the freeze-drying phase itself, where the medicine product M loses, through sublimation (evaporation), its liquid phase, such as indicated by arrows I, and the only the powdered form of the medicine, product M remains within the bottle.

FIG. 12 shows the following stage regarding those demonstrated on FIG. 11, where after the full evaporation of the liquid phase of the medicine product M inside the bottle F, the cap 1 that closes the bottle F received an overcap 2, which is threaded to the cap 1 through the “luer” terminals. The “J” arrows show the clockwise rotation direction needed for the assembly of the overcap 2 with the cap 1, while the “K” arrow indicates the direction of resulting approach between the overcap 2 and cap 1.

FIGS. 10, 11 and 12 seek to schematically show the fact that the cap assembly 100, considering that the cap 1 and its overcap 2 might be initially separated, and subsequently joined permanently by the weld S, is usable for providing sealing to bottles with liquid medicine products M which must be submitted to freeze-drying processes.

FIG. 13 shows a first variation of the cap presented herein, which, as an assembly, is indicated by reference 110.

The assembly 110 of the cap presented herein and shown on FIGS. 13, 14, 15, 16 and 17 is a version destined particularly for use in bottles F which shall be filled with liquid medicine products that will be submitted to freeze-drying processes.

The assembly 110, differently from what was verified regarding the assembly 100 shown on FIGS. 10, 11 and 12, does not require its overcap 2 to be separated from the cap 1 at the moment of the freeze-drying process.

On the assembly 110, the cap 1 has a central projection 14, which presents a slightly conic lower end 15, while the upper portion of this central projection 14 incorporates outlet openings 16 positioned equidistantly.

On the assembly 110 the overcap 2 does not differ from the model of assembly 100, and the same occurs in fact regarding cap 1, being the only exception the provision of the aforementioned central projection 14. The assembly 110 features the same basic details regarding its cap 1 and overcap 2, which are found on the assembly 100.

The assembly 110, such as the one verified regarding assembly 100, has its cap 1 formed by a disc-shaped section 3, which is augmented by a surrounding vertical wall 4, the latter being covered, in its internal and lower region, by a thick edge bent inwards 5.

From the center of the circular face of the disc-shaped section 3, a tube connection 6, elaborated in the “luer” standard goes vertically upwards, having in its outer wall an outer screw cap wire 7, with this last detail particularly indicated on FIG. 14.

The periphery of the circular face of the disc-shaped section 3 of the cap 1 features an outstanding upwards border 8 which ends in an acute edge 9, while the botton face 10 of the disc-shaped section 3 is supported by the bottleneck F1 of bottle. The aforementioned details are also indicated particularly on FIG. 14.

The overcap 2 of assembly 110, such as verified regarding assembly 100, has a disc format featuring a surrounding wall 11, dimensioned in order to have, preferably, the same diameter as the cap 1.

The central and lower regions of the overcap 2 of assembly 110 feature a tube projection 13, also according to the “luer” standard 6 and with an internal thread wire 13′, which complements and connects to the “luer” connection 6 through the thread wire 7, which is part of the cap 1. The tube projection 13 features a cylindrical projection 13A centrally and coaxially positioned, which enters the tube connection 6 of the cap 1.

Also regarding assembly 110, edges 9 and 12 of cap 1 and overcap 2 are expected, which are produced so that they may be joined by a weld S and, when united, define the breaking line R.

The central projection 14 of the assembly 110 makes all the difference, since it enables said assembly to be preliminarily mounted on the bottle F, as shown on FIG. 15, in a condition which matches the outlet openings 16 placed above the upper border of the bottleneck F1 of the bottle F.

This way, when the freeze-drying phase of the medicine product M itself takes place, its liquid phase may evaporate and flow out of the bottle F through the outlet openings 16, as can be comprehended through observation of FIG. 16, as indicated by the “I” arrows.

Upon conclusion of the freeze-drying process, the medicine product M, in powder state, may be definitely closed within the bottle F through the lowering of the assembly 110, as shown on FIG. 17 and as indicated by the “K” arrow.

When lowered, under pressure, the assembly 110 establishes with the bottle F a condition of retention regarding its cap 1, such as verified regarding the assembly 100, but in such condition the outlet openings 16 are then obstructed by the bottleneck wall F3 of the bottle F. When the assembly 110 is lowered, the thick border 5 of the cap 1 is then locked against the surrounding border F2 of the bottle F.

FIGS. 15, 16 and 17 demonstrate that the cap assembly 110 is complete since the initial stage shown on FIG. 15, or in other words, the cap assembly 110 might have its cap 1 and respective overcap 2 previously joined together permanently through welding, being applied in this condition to the bottle F and maintaining such condition even after the conclusion of its attachment to the bottle F, as specifically shown on FIG. 17.

FIG. 16 clearly and evidently shows the fact that the steam generated by sublimation of the liquid phase of the medicine product M finds on the outlet openings 16 a quick outlet option, such as indicated by the “I” arrows.

FIG. 18 shows a second variation of the cap presented herein, which, as an assembly, is indicated by reference 120 and presents a distinct setup regarding the overcap 2 and employs, as a strengthening resource for fixation of the cap 1 to the bottle F, a re-sealing seal 17.

The overcap 2 of the cap assembly 120 differs from the overcap 2 used in assemblies 100 and 110 exclusively due to having a relatively lower diameter.

The reduction of diameters for overcap 2 aims to enable that the re-sealing seal 17, which may be manufactured in plastic, advances with its upper border 18 over the upper wall of the disc-shaped section 3 of the cap 1.

The cap 1 of the assembly 120 differs from the model adopted for assemblies 100 and 110 due to the fact that its edge 9 has a disposition with reduced diameter in the same diameter as the edge 12 of the overcap 2.

The use of the re-sealing seal 17 on the cap assembly 120 seeks to improve the connection between cap 1 (and consequently also its overcap 2) with the bottle F (not showed on Figures and 19), mainly due to the fact that the re-sealing seal 17 reinforces, with its lower border 19, the role of the thick curved border 5 which integrates the structure of the cap 1 over the border F2 of the bottle F. Excluding the re-sealing seal 17, the assembly 120 features the same basic details regarding its cap 1 and overcap 2 and which are also found on the assembly 100.

The cap 1 of the assembly 120 is formed by a disc-shaped section 3 which is complemented by a surrounding vertical wall 4, the latter being covered in the lower region by a thick curved edge 5, while from the center of the circular face of the disc-shaped section 3, a tube connection 6 elaborated in the “luer” standard goes vertically upwards, having in its outer wall an outer screw cap wire 7.

The periphery of the circular face of the disc-shaped section 3 of the cap 1 features an outstanding upwards border 8 which ends in an acute edge 9, while the inner face 10 of the disc-shaped section 3 is upheld in the bottlehead of the respective bottle.

The overcap 2 of assembly 120, such as verified regarding assembly 100, has a disc format featuring a surrounding wall 11, dimensioned in order to have, as per already explained, a smaller diameter than the one verified on cap 1.

The central and lower regions of the overcap 2 of assembly 120 feature a tube projection 13, also according to the “luer” standard 6 and with an internal outer screw cap wire 13′, which complements and connects to the “luer” connection 6 through the outer screw cap wire 7, which is part of the cap 1. The tube projection 13 features a cylindrical projection 13A centrally and coaxially positioned, which enters the tube connection 6 of the cap 1.

Also regarding assembly 120, edges 9 and 12, when joined by welding S, define the rupture line R.

FIG. 20 shows a schematic sectional view of a third variation of the cap presented herein, which is indicated, as an assembly, by reference 130.

The assembly 130 is basically a sub-variant of the assembly 100, differing from the latter due to including a central projection 20 on its lower region, with said central projection 20 having a slightly conic lower end 21, such as verified with the central projection 14 used on the assembly 110.

The central projection 20 functions as a facilitating guide for fixation of the cap 1 to the top F1/bottleneck F2 of the bottle F (the bottle F is not specifically shown on FIG. 20). The assembly 130 features the same basic details regarding the cap 1 and overcap 2, which are found on the assembly 100.

The cap 1 of the assembly 130 is formed by a disc-shaped section 3 which is complemented by a surrounding vertical wall 4, the latter being covered in the lower region by a thick inward curved border 5, while from the center of the circular face of the disc-shaped section 3, a tube connection 6 elaborated in the “luer” standard goes vertically upwards, having in its outer wall an outer screw cap wire 7.

The periphery of the circular face of the disc-shaped section 3 of the cap 1 features an outstanding upwards border 8 which ends in an acute edge 9, while the inner face 10 of the disc-shaped section 3 is upheld in the bottlehead F1 of the bottle. The acute edge 9, when joined by welding S to the edge 12 of overcap 2, defines, together, the breaking line R.

The overcap 2 of assembly 130, such as verified regarding assembly 100, has a disc format featuring a surrounding wall 11, dimensioned in order to have a diameter equal to the one verified on cap 1.

The central and lower regions of the overcap 2 of assembly 130 feature a tube projection 13, also according to the “luer” standard and with an internal screw cap wire 13′, which complements and connects to the “luer” connection 6 through a screw cap wire 7, which is part of the cap 1. The tube projection 13 features a cylindrical projection 13A centrally and coaxially positioned, which enters the tube connection 6 of the cap 1.

FIG. 21 shows a fourth variation of the cap presented herein, which, as an assembly, is indicated by reference 140. The cap assembly 140 includes a cap 1 and its respective overcap 2, with the overcap 2 having the same diameter setup adopted by the cap 2 employed on the assembly 120, also adopting the re-sealing seal 17.

The cap 1 of the assembly 140 features a version of the central projection 20 adopted on the assembly 130, and differs from it due to fact that it yet includes a surrounding rib 22 placed on the outer region of the central projection 20 in order to provide a sealed connection with a surrounding lower section, normally provided on the inner region of the bottleneck F3 of the bottle F. The provision of a surrounding rib 22 on the central projection 20 has the function of increasing both the retaining conditions of the cap 1 regarding the bottle F, through the attachment of said rib 22 against one of the ring-shaped lower sections F4 provided on the inner wall of the bottleneck F3, as well as hermetic sealing conditions between both. FIG. 21A, which is an expanded detailed and schematic section taken from FIG. 21 includes the representation of the bottleneck section F3 of a typical bottle F and where the attachment between the rib 22 of the projection 20 and the lower section F4 of the bottleneck F3 of the bottle F may be viewed.

The assembly 140 features the same basic details regarding the cap 1 and overcap 2, which are found on the assembly 100.

The cap 1 of the assembly 140 is formed by a disc-shaped section 3 which is complemented by a surrounding vertical wall 4, the latter being covered in the lower region by a thick inward curved border 5, while from the center of the circular face of the disc-shaped section 3, a tube connection 6 elaborated in the “luer” standard goes vertically upwards, having in its outer wall an outer screw cap wire 7.

The periphery of the circular face of the disc-shaped section 3 of the cap 1 features an outstanding upwards border 8 which ends in an acute edge 9, while the botton face 10 of the disc-shaped section 3 is upheld in the bottlehead F1 of the bottle.

The overcap 2 of assembly 140, such as verified regarding assembly 100, has a disc format featuring a surrounding wall 11, dimensioned in order to have a smaller diameter in relation to the one verified on cap 1.

The central and lower regions of the overcap 2 of assembly 140 feature a tube projection 13, also according to the “luer” standard and with an internal outer screw cap wire 13′, which complements and connects to the “luer” connection 6 through the screw cap wire 7, which is part of the cap 1. The tube projection 13 features a cylindrical projection 13A centrally and coaxially positioned, which enters the tube connection 6 of the cap 1.

The acute edges 9 and 12, when joined by welding S to the edge 12 of overcap 2 define, together, the breaking line R.

The FIG. 22 shows a fifth variant of the cap, object of this invention patent application, which, as assembly, is indicated by the numeric reference 150. The assembly 150 derives from the assembly 140 cap model and includes one central projection in the molds of the one verified in the assembly 110 and that is indicated by the numeric reference 14, which is having one slightly conical bottom end 15, while the upper portion of this central projection 14 incorporates through-holes 16 arranged in an equidistant way. The central projection 14 still has one contouring rib 22, which has the function of raising the retention condition of the cap 1 regarding the bottle F by coupling the mentioned rib 22 against the ring recess F4 provided in the neck internal wall F3 of the bottles F normally used, such that already showed regarding what is pictured in the FIG. 21A. The assembly 150 shows the same basic details regarding its cap 1 and overcap 2 and the ones found in the assembly 100.

The assembly 150 cap 1 is formed by one disc-shaped section 3 that is complemented by one vertical contouring wall 4, this latter being garnished downward by one thicken and turned inward border 5, so from the center of the circular face of the disc-shaped section 3, one tubular connection 6 elaborated in the “luer” standard goes vertically upwards, having in its outer wall one outer screw cap wire 7.

The circular face periphery of the disc-shaped section 3 of the cap 1 shows one upwards prominent border 8 ending in one sharp edge 9, while the underside 10 of the disc-shaped section 3 is upheld in the bottlehead.

The assembly 150 overcap 2, such as the one verified regarding the assembly 100, shows one disc shape having one contouring wall 11 sized to have one diameter measure smaller than the one verified in the cap 1.

The central and bottom region of the assembly 150 overcap 2 shows one tubular projection 13 also in the “luer” standard and having one internal screw cap wire 13, which complements and connects to the “luer” connection 6 through the screw cap wire 7 that is part of the cap 1. The tubular projection 13 has one cylindrical projection 13A central and coaxially positioned, which enters into the tubular connection 6 of the cap 1. The assembly 150 é complemented by one re-sealing seal 17. The edges 9 and 12, when joined by welding define, together, the breakage line R.

The FIG. 23 shows a sixth variant of the cap hereof, which, as assembly, is indicated by the reference 160 and derives from the assembly 150 model pictured in the FIG. 22. The variant 160 includes one cap 1, which, around its “luer” connection 6, incorporates one low and contouring wall 23 with smaller diameter having one outer contouring rib 24, against which to match one inner contouring rib 25 from one contouring wall 26 with higher diameter beginning from the overcap 2 underside.

The assembly 160 overcap 2 further maintains the cylindrical projection 13A beginning from its center and that is sized to be inserted inside the “luer” connection 6 of the cap 1.

The contouring walls 23 and 26 correspond to one alternative to ensure the overcap 2 assembling against the cap 1 without requiring using threads.

The assembly 160 cap 1 has one central projection 14, which has one slightly conical bottom end 15, while the upper portion of this central projection 14 incorporates through-holes 16 arranged equidistantly.

The assembly 160 shows the same basic details regarding its cap 1 and overcap 2 and that are found in the assembly 100.

The assembly 160 cap 1 is formed by one disc-shaped section 3 that is complemented by one vertical contouring wall 4, this latter being garnished downward by one thicken and turned inward border 5.

The circular face periphery of the disc-shaped section 3 of the cap 1 shows one upwards prominent border 8 ending in one sharp edge 9, while the underside 10 of the disc-shaped section 3 is upheld in the bottlehead.

The assembly 160 overcap 2, such as the one verified regarding the assembly 100, shows one disc shape having one contouring wall 11 sized to have one diameter measure equal to the one verified in the cap 1.

In the case of the assembly 160 and such as the one verified in the preceding variants, the edges 9 and 12, when joined by welding, define together, the breakage line R.

The FIG. 24 shows a seventh variant of the cap, object of this invention patent application, which, as assembly, is indicated by the reference 170. The assembly 170 is one model variation of the assembly 160 cap, which differs from this last assembly by including the central projection 20, serving as facilitating guide to attach the cap, for use in bottles F for filled products that need to be subject to the freeze-drying process. In the assembly 170, such as the one verified regarding the assembly 160, the cap 1 has around its “luer” connection 6 one low and contouring wall 23 with smaller diameter having one outer contouring rib 24, against which is to match one inner contouring rib 25 from one contouring wall 26 with higher diameter and beginning from the underside of the overcap 2. The assembly 170 cap 1 further maintains the cylindrical projection 13A beginning from its center and that is sized to be inserted inside the “luer” connection 6 of the cap 1.

The contouring walls 23 and 26 embedded in the cap 1 and overcap 2 of the assembly 170, such as the one verified regarding the assembly 160, correspond to one alternative to ensure the overcap 2 assembling against the cap 1 without requiring the use of threads.

The assembly 170 shows the same basic details regarding its cap 1 and overcap 2 and that are found in the assembly 100.

The assembly 170 cap 1 is formed by one disc-shaped section 3 that is complemented by one vertical contouring wall 4, this latter being garnished downward by one thicken and turned inward border 5.

The circular face periphery of the disc-shaped section 3 of the cap 1 shows one upwards prominent border 8 ending in one sharp edge 9, while the underside 10 of the disc-shaped section 3 is upheld in the bottlehead.

The assembly 170 overcap 2, such as the one verified regarding the assembly 100, shows one disc shape having one contouring wall 11 sized to have one diameter measure equal to the one verified in the cap 1.

In the case of the assembly 170 and such as the one verified in the preceding variants, the edges 9 and 12, when joined by welding, define together, the breakage line R.

The FIG. 25 shows an eighth variant of the cap, object of this invention patent application, which, as assembly, is indicated by the numeric reference 180. The assembly 180 includes the cap 1 arrangement, such as the one verified in the assembly 160, however it links this arrangement to employ one re-sealing seal 17, the reason why the overcap 2 shows one arrangement with reduced diameter, such as the one verified, for example, in the assembly 150.

The cap assembly 180 also includes one central projection 20, analogous to the one verified in the assembly 140 pictured in the FIG. 21, being this central projection 20 having one contouring rib 22 equally. The attachment system of the overcap 2 against the cap 1 follows the same solution adopted in the assemblies 160 and 170, where the cap 1 has around its “luer” connection 6 one low and contouring wall 23 with smaller diameter having one outer contouring rib 24, against which is to match one inner contouring rib 25 from one contouring wall 26 with higher diameter and that, in the present case, constitutes the outer wall 11 of the overcap 2. The assembly 180 cap 1 further maintains the cylindrical projection 13A beginning from its center and that is sized to be inserted inside the “luer” connection 6 of the cap 1.

The contouring walls 23 and 26 embedded in the cap 1 and overcap 2 of the assembly 180, such as the one verified regarding the assemblies 160 and 170, correspond to one alternative to ensure the overcap 2 assembling against the cap 1 without requiring the use of threads.

The assembly 180 shows the same basic details regarding its cap 1 and overcap 2 and that are found in the assembly 100.

The assembly 180 cap 1 is formed by one disc-shaped section 3 that is complemented by one vertical contouring wall 4, this latter being garnished downward by one thicken and turned inward border 5.

The circular face periphery of the disc-shaped section 3 of the cap 1 shows one upwards prominent border 8 ending in one sharp edge 9, while the underside 10 of the disc-shaped section 3 is upheld in the bottlehead.

The assembly 180 overcap 2, such as the one verified regarding the assembly 100, shows one disc shape having the contouring wall 11 already mentioned, but sized to have one diameter measure smaller than the one verified in the cap 1. In the case of the assembly 180 and such as the one verified in the preceding variants, the edges 9 and 12, when joined by welding, define together, the breakage line R.

The FIGS. 26 and 27 show a ninth variant of the cap here proposed, which, as assembly, is indicated by the reference 190 and links the assembly 180 cap 1 to one modality of the overcap 2, which has one single discoid portion 27 that is held by the upper border 18 of the re-sealing seal 17.

The assembly 190 overcap 2 shows one portion with smaller diameter 28, in the same molds of the one verified, for example, in the assembly 180 pictured in the FIG. 25.

The assembly 190 re-sealing seal 17, besides the function of ensuring the attachment of the cap 1 to the bottle, has also the function of joining the overcap 2 to the cap body 1.

The assembly 190 cap 1 further maintains the cylindrical projection 13A beginning from its center and that is sized to be inserted inside the “luer” connection 6 of the cap 1.

The assembly 190 cap 1 is formed by one disc-shaped section 3 that is complemented by one vertical contouring wall 4.

The assembly 190 overcap 2, such as the one verified regarding the assembly 100, shows one disc shape having the contouring wall 11 already mentioned, but sized to have one diameter measure smaller than the one verified in the cap 1.

The vertical contouring wall 4 of the assembly 190 cap 1 is garnished downward by one thicken and turned inward border 5.

In the case of the assembly 190, and in a different way from the one verified in the preceding variants, the rupture line R may be established at the overcap assembling moment 2, such that the edges 9 and 12 are already produced in a totally linked way, which means that the mentioned rupture line R is exclusively positioned in the overcap 2.

Consequently, the assembly 190 dismisses to adopt the welding procedure of the region to join the edges 9 and 12 of the cap 1 and overcap 2, given that as upstanding component, the overcap 2 is fixed to the cap 1 by the re-sealing seal 17 acting, such overcap 2 must be positioned over the cap 1 before performing the re-sealing seal 17 application.

1. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, which predicts a model, which as assembly is indicated by the reference (100), wherein it includes a cap itself that is indicated by the numeric reference (1), which is complemented by an overcap (2), being the cap (1) a piece produced in plastic polymer achieved by injection molding and it is formed by a disc-shaped section (3) that is complemented by one vertical contouring wall (4), the latter being garnished downward, in its internal region, by one thicken and turned inward edge (5); from the center of the circular face of the disc-shaped section (3) one tubular connection (6) elaborated in the “luer” standard goes vertically upwards, having in its outer wall an outer screw cap wire 7; the circular face periphery of the cap (1) disc-shaped section (3) shows one upwards prominent border (8) ending in one sharp edge (9), while the underside (10) of the disc-shaped section (3) is upheld in the bottlehead (F1) of the bottle (F); the assembly (100) further has one overcap (2), which is also produced in plastic polymer and by injection molding process; the overcap (2) shows a disc shape having one contouring wall (11), sized to have the same diameter measure of the cap (1); the bottom border of the contouring wall (11) ends in one sharp edge (12) identical to the edge (9) built to the cap (1); the central and bottom region of the overcap (2) shows one tubular projection (13) also in the “luer” standard and having an internal screw cap wire (13′), which contemplates and connects to the “luer” connection (6) through the screw cap wire (7) that is part of the cap (1); the tubular projection (13) has one cylindrical projection (13A) central and coaxially positioned, which enters into the tubular connection (6) of the cap (1); the edges (9) and (12) of the cap (1) and overcap (2) are produced in a way they face each other and may be joined by welding (S), being this welding line S forms the region or line (R) of breakage to be effectively broken at the separation moment of the overcap (2) regarding the cap (1).

2. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 1, wherein the cap (1) and overcap (2) assembly (100) proposed herein may be assembled in a bottle generic model (F) so this assembling is performed such that the underside (10) of the cap (1) contacts the bottlehead upper border (F1) of the bottle (F), at the same time that the thicken and turned inward border (5) sets one locking condition with the contouring border (F2) of the mentioned bottle (F), so the said cap assembly (100) constituting the cap main model here handled is performed so that may be assembled against the bottle (F) by compression effect, being the retention generated by the thicken and turned inward border (5) of the cap (1) and the contouring border (F2) of the bottle (F); after filling the product inside the bottle (F) this is then closed by applying the cap (1) and its overcap (2) against the said bottle, so the cap and overcap assembly has previously been welded from the edges (9) and (12), while during the bottle opening (F) the overcap (2) must be turned while is separated from the cap (1), this operation requires the breakage line rupture (R) so far established welding (S) the edges (9) and (12).

3. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 1, wherein when it is removed the overcap (2) from the cap (1), the “luer” connection (6) of the cap (1) allows the coupling procedure occurs, to the cap (1), from one hypodermic syringe (SH).

4. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 1, wherein when it is removed the overcap (2) from the cap (1), the cap (1) “luer” connection (6) allows the coupling procedure occurs, to the cap (1), from one bag (B) having one entrance door (B1).

5. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 1, wherein the assembly (100) hereof may be employed with bottles (F) that must be filled with liquid medicines that will be processed by freeze-drying.

6. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 1, wherein a first variant of the cap hereof is foreseen, which, as assembly, is indicated by the reference (110); the cap assembly (110) hereof is one version for use in bottles (F) that have to be filled with liquid medicines that will be processed by freeze-drying; the assembly (110), regarding its cap (1) has one central projection (14) presenting one slightly conical bottom end (15), while the upper portion of thus central projection (14) incorporates through-holes (16) arranged in a equidistant way; the assembly (110) has its cap (1) formed by one disc-shaped section (3) that is complemented by one vertical contouring wall (4), this latter being garnished downward, in its internal region, by one thicken and turned inward border (5); from the center of the circular face of the disc-shaped section (3) one tubular connection (6) elaborated in the “luer” standard goes vertically upwards, having in its outer wall one outer screw cap wire (7); the circular face periphery of the cap (1) disc-shaped section (3) shows one upwards prominent border (8) ending in one sharp edge (9), while the underside (10) of the disc-shaped section (3) is upheld in the bottlehead (F); the assembly (110) overcap (2) shows one disc shape having one contouring wall (11), sized to have the same diameter measure of the cap (1); the central and bottom region of the assembly (110) overcap (2) shows one tubular projection (13) also in the “luer” standard (6) and having one internal screw cap wire (13′), which complements and connects to the “luer” connection (6) through the outer screw cap wire (7) that is part of the cap (1); the tubular projection (13) has one cylindrical projection (13A) central and coaxially positioned, which enters into the tubular connection (6) of the cap (1); in the assembly (110) edges (9) in the cap (1) and edges (12) in the overcap (2) are foreseen, which are produced in a way that may be joined by welding (S) and when joined they define the rupture line (R).

7. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 6, wherein the central projection (14) of the assembly (110) allows the assembly (110) to be preliminarily assembled in the bottle (F) in one condition that coincides with the through-holes (16) arranged above the mouth upper border (F1) of the bottle (F), such that when the medicine (M) freeze-drying effective phase starts, the liquid phase thereof may evaporate and move outward the bottle (F) through the through-holes (16), so when finishing the freeze-drying phase the medicine (M), in powder, may be definitely closed inside the bottle (F) by lowering, under pressure, the assembly (110), thus determining that the assembly (110) establishes with the bottle (F) one retention condition regarding its cap (1), so in such condition the through-holes (16) are then clogged by the bottle (F) neck (F3) wall; when the assembly (110) is lowered the locking of the thicken border (5) of the cap (1)is established against the contouring border (F2) of the bottle (F); the assembly (110) is coupled to the bottle (F) in full assembling condition since the starter stage, which may have its cap (1) and its respective overcap (2) previously joined definitively by welding (S), being applied in this condition to the bottle (F); in the assembly (110), the steam derived from the medicine (M) liquid phase of the medicine sublimation finds in the through-holes (16) one output route.

8. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 6, wherein the assembly (110), when it has the overcap (2) removed from its cap (1) allows the coupling procedure occurs, to the cap (1), from one hypodermic syringe (SH) through its “luer” connection (6).

9. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 6, wherein when it is removed the overcap (2) from the cap (1), the cap (1) “luer” connection (6) allows the coupling procedure occurs, to the cap (1), from one bag (B) having one entrance door (B1).

10. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 1, wherein a second variant of the cap hereof is foreseen, which, as assembly, is indicated by the reference (120); the assembly (120) shows one differentiated configuration regarding the overcap (2) and employs, as reinforcement resource for fixing the cap (1) to the bottle (F), one re-sealing seal (17); the overcap (2) of the cap assembly (120) shows one reduced diameter regarding the cap (1) to allow the re-sealing seal (17) move forward with its upper border (18) over the cap (1) disc-shaped section (3) upper wall; the cap (1) of the assembly (120) has its edge (9) in one arrangement presenting one diameter reduction in the same measurement of the overcap (2) edge (12) diameter; to use the re-sealing seal (17) in the cap assembly (120) complements the linking between the cap (1) with the bottle (F), which the re-sealing seal (17) reinforces, with its bottom border (19), the thicken and turned border (5) acting that integrates the cap structure (1) acting over the border F2 of the bottle (F); the cap 1 of the assembly (120) is formed by one disc-shaped section (3) that is complemented by one vertical contouring wall (4), this latter being garnished downward by one thicken and turned inward border (5), so from the center of the circular face of the disc-shaped section (3) one tubular connection (6) elaborated in the “luer” standard goes vertically upwards, having in its outer wall one outer screw cap wire (7); the circular face periphery of the cap (1) disc-shaped section (3) shows one upwards prominent border (8) ending in the sharp edge (9) already mentioned, while the underside (10) of the disc-shaped section (3) is upheld in the bottlehead (F); the overcap (2) of the assembly (120) shows one disc shape having one contouring wall (11); the assembly (120) overcap (2) central and bottom region shows one tubular projection (13) also in the “luer” standard having one internal screw cap wire (13), which complements and connects to the “luer” connection (6) through the outer screw cap wire (7) that is part of the cap (1); the tubular projection (13) has one cylindrical projection (13A) central and coaxially positioned, which enters into the tubular connection (6) of the cap (1); in the assembly (120), the edges 9 and 12, when joined by welding (S) define the rupture line (R).

11. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, “CAP ASSEMBLY HAVING HYPODERMIC SYRINGE COUPLING CONNECTION AND OVERCAP FOR USE IN SEALING OF BOTTLES FOR PACKAGING PHARMACEUTICAL AND INJECTABLE MEDICINE PRODUCTS” according to claim 10, wherein the re-sealing seal (17) may be produced in plastic.

12. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 10, wherein the assembly (120), when it has removed the overcap (2) from its cap (1), allows the coupling procedure occurs, to the cap (1), from one hypodermic syringe (SH) through its “luer” connection (6).

13. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 10, wherein when it is removed the overcap (2) from the cap (1), the cap (1) “luer” connection (6) allows the coupling procedure occurs, to the cap (1), from one bag (B) having one entrance door (B1).

14. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 1, wherein a third variant of the cap hereof is foreseen, which is indicated, as assembly, by the reference (130); the assembly (130) includes, in its cap central region (1), one central projection (20), which has one conical bottom end (21); the central projection (20) has the function of serving as guide to fix the cap (1) in the bottlehead (F1)/neck (F2) of the bottle (F); the assembly (130) cap (1) is formed by one disc-shaped section (3) that is complemented by one vertical contouring wall (4), this latter being garnished downward by one thicken and turned inward border (5), so from the center of the circular face of the disc-shaped section (3) one tubular connection (6) elaborated in the “luer” standard goes vertically upwards, having in its outer wall one outer screw cap wire (7); the circular face periphery of the cap (1) disc-shaped section (3) shows one upwards prominent border (8) ending in one sharp edge (9), while the underside (10) of the disc-shaped section (3) is upheld in the bottlehead (F); the sharp edge (9), when joined by welding (S) to the overcap (2) edge (12) defines, together, the breakage line (R); the overcap (2) of the assembly (130) shows one disc shape having one contouring wall (11) sized to have one diameter measure equal to the one verified in the cap (1); the central and bottom region of the assembly (130) overcap (2) shows one tubular projection (13) in the “luer” standard having one internal screw cap wire (13), which complements and connects to the “luer” connection (6) through the outer screw cap wire (7) that is part of the cap (1); the tubular projection (13) has one cylindrical projection (13A) central and coaxially positioned, which enters into the tubular connection (6) of the cap (1).

15. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 14, wherein the assembly (130), when it has removed the overcap (2) from its cap (1),allows the coupling procedure occurs, to the cap (1), from one hypodermic syringe (SH) through its “luer” connection (6).

16. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 14, wherein when the overcap (2) is removed from the cap (1), the cap (1) “luer” connection (6) allows the coupling procedure occurs, to the cap (1), from one bag (B) having one entrance door (B1).

17. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 1, wherein a fourth variant of the cap hereof is foreseen, which, as assembly, is indicated by the reference (140), where the cap assembly (140) includes one cap (1) and its respective overcap (2), so the overcap (2) shows one smaller diameter measure regarding its corresponding cap (1), cap (1) that is garnished by one re-sealing seal (17); the assembly (140) cap (1) shows one central projection (20) that includes one contouring rib (22) arranged in the central projection outer region (20) in such a way that the sealing linking with one contouring ring recess (F4) normally provided in the neck internal region (F3) of the bottle (F); the provision of contouring rib (22) to the central projection (20) raises either the cap (1) retention condition regarding the bottle (F), by coupling the mentioned rib (22) against one ring recess (F4) provided in the neck internal wall (F3), as also the hermetic closing condition between both; the assembly (140) cap (1) is formed by one disc-shaped section (3) that is complemented by one vertical contouring wall (4), this latter being garnished downward by one thicken and turned inward border (5), so from the center of the circular face of the disc-shaped section (3) one tubular connection (6) elaborated in the “luer” standard goes vertically upwards, having in its outer wall one outer screw cap wire (7); the circular face periphery of the cap (1) disc-shaped section (3) shows one upwards prominent border (8) ending in one sharp edge (9), while the underside (10) da disc-shaped section (3) is upheld in the bottlehead (F); the assembly (140) overcap (2) shows one disc shape having one contouring wall (11) sized to have one diameter measure smaller than the one verified in the cap (1); the central and bottom region da assembly (140) overcap (2) shows one tubular projection (13) also in the “luer” standard having one internal screw cap wire (13), which complements and connects to the “luer” connection (6) through the screw cap wire (7) that is part of the cap (1); the tubular projection (13) has one cylindrical projection (13A) central and coaxially positioned, which enters into the tubular connection (6) of the cap (1); the edges (9) and (12), when joined by welding (S) define, together, the breakage line (R).

18. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 17, wherein the assembly (140), when it has removed the overcap (2) from its cap (1), allows the coupling procedure occurs, to the cap (1), from one hypodermic syringe (SH) through its “luer” connection (6).

19. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 17, wherein when the overcap (2) is removed from the cap (1), the cap (1) “luer” connection (6) allows the coupling procedure occurs, to the cap (1), from one bag (B) having one entrance door (B1).

20. “CAP ASSEMBLY HAVING HYPODERMIC SYRINGE COUPLING CONNECTION AND OVERCAP FOR USE IN SEALING OF BOTTLES FOR PACKAGING PHARMACEUTICAL AND INJECTABLE MEDICINE PRODUCTS” according to claim 1, wherein a fifth variant of the cap object of this invention patent application is foreseen, which, as assembly, is indicated by the numeric reference (150); the assembly (150) includes one central projection indicated by the numeric reference (14), which has one conical bottom end (15), while the upper portion of this central projection (14) incorporates through-holes (16) arranged in a equidistant way; the central projection (14) still has one contouring rib (22), which raises the cap (1) retention condition regarding the bottle (F) by coupling the mentioned rib (22) against the ring recess (F4) provided in the neck internal wall (F3) of the bottle (F); the assembly (150) cap (1) is formed by one disc-shaped section (3) that is complemented by one vertical contouring wall (4), this latter being garnished downward by one thicken and turned inward border (5), so from the center of the circular face of the disc-shaped section (3) one tubular connection (6) elaborated in the “luer” standard goes vertically upwards, having in its outer wall one outer screw cap wire (7); the circular face periphery of the cap (1) disc-shaped section (3) shows one upwards prominent border (8) ending in one sharp edge (9), while the underside (10) of the disc-shaped section (3) is upheld in the bottlehead (F); the assembly (150) overcap (2) shows one disc shape having one contouring wall (11) sized to have one diameter measure smaller than the one verified in the cap (1); the central and bottom region of the assembly (150) overcap (2) shows one tubular projection (13) also in the “luer” standard and having one internal screw cap wire (13), which complements and connects to the “luer” connection (6) through the screw cap wire (7) that is part of the cap (1); the tubular projection (13) has one cylindrical projection (13A) central and coaxially positioned, which enters into the tubular connection (6) of the cap (1); the assembly (150) is complemented by one re-sealing seal (17); the edges (9) and (12), when joined by welding define, together, the breakage line (R).

21. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 20, wherein the assembly (150), when it has removed the overcap (2) from its cap (1), allows the coupling procedure occurs, to the cap (1), from one hypodermic syringe (SH) through its “luer” connection (6).

22. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 20, wherein when the overcap (2) is removed from the cap (1), the cap (1) “luer” connection (6) allows the coupling procedure occurs, to the cap (1), from one bag (B) having one entrance door (B1).

23. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 1, wherein a sixth variant of the cap hereof is foreseen, which, as assembly, is indicated by the reference (160) and includes one cap (1), which around its “luer” connection (6) incorporates one low and contouring wall (23) with smaller diameter having one outer contouring rib (24), against which is to match one inner contouring rib (25) from one contouring wall (26) with higher diameter beginning from the underside da overcap (2); the assembly (160) overcap (2) still maintains the cylindrical projection (13A) beginning from its center and that is sized to be inserted inside the cap (1) “luer” connection (6); the assembly (160) cap (1) has one central projection (14), which has one slightly conical bottom end (15), while the upper portion of this central projection (14) incorporates through-holes (16) arranged in an equidistant way; the assembly (160) cap (1) is formed by one disc-shaped section (3) that is complemented by one vertical contouring wall (4), this latter being garnished downward by one thicken and turned inward border (5); the circular face periphery of the cap (1) disc-shaped section (3) shows one upwards prominent border (8) ending in one sharp edge (9), while the underside (10) of the disc-shaped section (3) is upheld in the bottlehead (F); the assembly (160) overcap (2), such as the one verified regarding the assembly 100, shows one disc shape having one contouring wall (11) sized to have one diameter measure equal to the one verified in the cap (1); the edges (9) and (12), when joined by welding define, together, the breakage line (R).

24. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 23, wherein the assembly (160), when it has removed the overcap (2) from its cap (1), allows the coupling procedure occurs, to the cap (1), from one hypodermic syringe (SH) through its “luer” connection (6).

25. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 23, wherein when the overcap (2) is removed from the cap (1), the cap (1) “luer” connection (6) allows the coupling procedure occurs, to the cap (1), from one bag (B) having one entrance door (B1).

26. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 1, wherein a seventh variant of the cap hereof is foreseen, which, as assembly, is indicated by the reference (170); the assembly (170) includes one cap (1) having one central projection (20), serving as a guide to fix the cap (1), for use in bottles (F) for packaging products that do not need to be subject to freeze-drying process; in the assembly (170) the cap 1 has, around its “luer” connection (6), one low and contouring wall (23) with smaller diameter having one outer contouring rib (24), against which is to match one inner contouring rib (25) from one contouring wall (26) with higher diameter and beginning from the underside of the overcap (2); the assembly (170) cap (1) has one cylindrical projection (13A) beginning from its center and that is sized to be inserted inside the cap (1) “luer” connection (6); the assembly (170) cap (1) is formed by one disc-shaped section (3) that is complemented by one vertical contouring wall (4), this latter being garnished downward by one thicken and turned inward border (5); the circular face periphery of the cap (1) disc-shaped section (3) shows one upwards prominent border (8) ending in one sharp edge (9), while the underside (10) of the disc-shaped section (3) is upheld in the bottlehead (F); the assembly (170) overcap (2) shows one disc shape having one contouring wall (11) sized to have one diameter measure equal to the one verified in the cap (1); the edges (9) and (12), when joined by welding (S), define together, the breakage line (R).

27. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 26, wherein the assembly (170), when it has removed the overcap (2) from its cap (1), allows the coupling procedure occurs, to the cap (1), from one hypodermic syringe (SH) through its “luer” connection (6).

28. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 26, wherein when the overcap (2) is removed from the cap (1), the cap (1) “luer” connection (6) allows the coupling procedure occurs, to the cap (1), from one bag (B) having one entrance door (B1).

29. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”,according to claim 1, wherein an eighth variant of the cap hereof is foreseen, which, as assembly, is indicated by the numeric reference (180); the assembly (180) includes one cap (1) employing one re-sealing seal (17); the overcap (2) shows one arrangement with reduced diameter regarding the diameter verified in the cap (1); the cap assembly (180) includes, in its cap (1), one central projection (20), being this central projection (20) having one contouring rib (22); the cap (1), has around its “luer” connection, (6) one low and contouring wall (23) with smaller diameter having one outer contouring rib (24), against which is to match one inner contouring rib (25) from one contouring wall (26) with higher diameter and constituting the outer wall (11) of the overcap (2); the cap (1) has one cylindrical projection (13A) beginning from its center and that is sized to be inserted inside the cap (1) “luer” connection (6); the assembly (180) cap (1) is formed by one disc-shaped section (3) that is complemented by one vertical contouring wall (4), this latter being garnished downward by one thicken and turned inward border (5); the circular face periphery of the cap (1) disc-shaped section (3) shows one upwards prominent border (8) ending in one sharp edge (9), while the underside (10) of the disc-shaped section (3) is upheld in the bottlehead (F); the overcap (2) do assembly (180) shows one disc shape having the contouring wall (11) sized to have one diameter measure smaller than the one verified in the cap (1); the edges (9) and (12), when joined by welding (S), define together, the breakage line (R).

30. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 29, wherein the assembly (180), when it has removed the overcap (2) from its cap (1), allows the coupling procedure occurs, to the cap (1), from one hypodermic syringe (SH) through its “luer” connection (6).

31. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 29, wherein when the overcap (2) is removed from the cap (1), the cap (1) “luer” connection (6) allows the coupling procedure occurs, to the cap (1), from one bag (B) having one entrance door (B1).

32. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 1, wherein a ninth variant of the cap hereof is foreseen, which, as assembly, is indicated by the reference (190) which has one overcap (2), which has one single discoid portion (27) that is held by the upper border (18) of the re-sealing seal (17); the overcap (2) of the assembly (190) shows one portion with smaller diameter (28); the re-sealing seal (17) of the assembly (190) has, besides the function of ensuring the cap attachment (1) to the bottle (F), also the function of joining the overcap (2) to the cap body (1); the cap (1) has one cylindrical projection (13A) beginning from its center and that is sized to be inserted inside the cap (1) “luer” connection (6); the cap (1) is formed by one disc-shaped section (3) that is complemented by one vertical contouring wall (4); the overcap (2) shows one disc shape having the contouring wall (11) sized to have one diameter measure smaller than the one verified in the cap (1); the vertical contouring wall (4) of the assembly (190) cap (1) is garnished downward by one thicken and turned inward border (5); the rupture line (R) being established at the overcap (2) assembling moment, such that the edges (9) and (12) are already produced totally linked, so, in the assembly (190) the rupture line (R) is exclusively positioned in the overcap (2).

33. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 32, wherein the assembly (190), when it has removed the overcap (2) from its cap (1),allows the coupling procedure occurs, to the cap (1), from one hypodermic syringe (SH) through its “luer” connection (6).

34. “CAP ASSEMBLY HAVING HYPODERMIC SYRINGE COUPLING CONNECTION AND OVERCAP FOR USE IN SEALING OF BOTTLES FILLED WITH PHARMACEUTICAL AND INJECTABLE MEDICINE PRODUCTS”, according to claim 32, wherein when the overcap (2) is removed from the cap (1), a cap (1) “luer” connection (6) allows the coupling procedure occurs, to the cap (1), from one bag (B) having one entrance door (B1).
